(19) United States
(12) Patent Application Publication
(10) Pub. No.: US 2025/0072507 A1
(43) Pub. Date: Mar. 6, 2025

(54) AEROSOL GENERATING DEVICE

(71) Applicant: NICOVENTURES TRADING LIMITED, London (GB)

(72) Inventors: Jonathan BURGESS, London (GB); Conor MCGRATH, London (GB); Sylwia KUZMICKA, London (GB); Peter DAVIS, London (GB)

(21) Appl. No.: 18/715,206

(22) PCT Filed: Nov. 7, 2022
(86) PCT No.: PCT/EP2022/081017

§ 371 Date: May 31, 2024

(30) Foreign Application Priority Data
Dec. 1, 2021 (GB) 2117352.1

(51) Int. Cl. A24F 40/465; A24F 40/20; H05B 6/10

(52) U.S. Cl. CPC A24F 40/465; A24F 40/20; H05B 6/108

(57) ABSTRACT

An aerosol generating device for generating an aerosol from aerosol-generating material. The device has a magnetic field generator with an inductor coil configured to generate a varying magnetic field. The device also has a heating element that is heatable by penetration with the varying magnetic field. The heating element defines a heating zone configured to receive at least a portion of an article including aerosol-generating material. The heating element is fixed relative to the inductor coil. The inductor coil encircles a first portion of the heating zone such that the first portion is heated at least predominantly by inductive heating. A second portion of the heating zone is free from being encircled by any inductor coil so that the second portion of the heating zone is heated predominantly by conductive heating.

### RELATED APPLICATIONS

The present application is a National Phase entry of PCT Application No. PCT/EP2022/081017 filed Nov. 7, 2022, which claims priority to GB Application No. 2117352.1 filed Dec. 1, 2021, each of which is hereby incorporated by reference in their entirety.

### TECHNICAL FIELD

The present invention relates to an aerosol generating device. The present invention also relates to an aerosol generating system comprising an aerosol generating device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect, there is provided an aerosol generating device for generating an aerosol from aerosol-generating material, the device comprising: a magnetic field generator comprising an inductor coil configured to generate a varying magnetic field; and a heating element that is heatable by penetration with the varying magnetic field, the heating element defining a heating zone configured to receive at least a portion of an article comprising aerosol-generating material; wherein the heating element is fixed relative to the inductor coil; wherein the inductor coil encircles a first portion of the heating zone such that the first portion is heated at least predominantly by inductive heating; and wherein a second portion of the heating zone is free from being encircled by any inductor coil so that the second portion of the heating zone is heated predominantly by conductive heating.

The heating element may define an opening at one end through which at least a portion of an article is receivable. The first portion of the heating zone may be proximal to the opening.

The heating element may define an opening at one end through which at least a portion of an article is receivable. The second portion of the heating zone may be distal to the opening.

The pitch of the inductor coil may be at least substantially constant along the length of the coil. The inductor coil may have a constant pitch along the length of the coil.

The heating zone may comprise a first end and a second end, the inductor coil being disposed between the first end and the second end.

The magnetic field generator may comprise a first connector portion at a first end of the inductor coil and a second connector portion at a second end of the inductor coil, and at least one of the first and second connector portions may extend at least partly in an axial direction of the aerosol generating device.

At least one of the first and second connector portions may at least partly overlap the second portion of the heating zone.

The at least one of the first and second connector portions may be linear.

At least one of the first and second connector portions may comprise an angled bend.

The angled bend may define a juncture between the inductor coil and the at least one of the first and second connector portions.

The angled bend may include an angle of between 45 degrees and 135 degrees.

An axial extent of the second portion may be between 10% and 80% of the axial extent of the heating element.

The inductor coil may comprise between 2 and 20 turns.

The heating element may be substantially tubular.

According to an aspect, there is provided an aerosol generating system comprising the aerosol generating device of the previous aspect and an article comprising aerosol generating material.

According to an aspect, there is provided an aerosol generating device for generating an aerosol from aerosol-generating material, the device comprising: a receptacle defining a heating zone and having a length along its longitudinal axis; an inductor coil extending around the receptacle and extending along at least a portion of the length of the receptacle; wherein the inductor coil comprises a first end portion disposed closest to a first end of the heating zone, and a second end portion disposed closest to a second end of the heating zone, wherein the first end portion of the inductor coil comprises a first number of turns per unit length such that at least a portion of a heating element received in the heating zone is heated predominantly by inductive heating; and wherein the second end portion comprises a second number of turns per unit length, the second number of turns per unit length being less than the first number of turns per unit length to the extent that at least a portion of a heating element received in the heating zone is heated predominantly by conduction.

The device may comprise a heating element that is heatable by penetration with the varying magnetic field.

The heating element may upstand in the receptacle.

The receptacle may comprise the heating element. The heating element may be tubular. The heating element may define the heating zone.

According to an aspect, there is provided a system comprising the aerosol generating device of the previous aspect and an article comprising aerosol generating material, the article comprising a heating element that is heatable by penetration with the varying magnetic field.

According to an aspect, there is provided an aerosol generating device for generating an aerosol from aerosol-generating material, the device comprising: a receptacle defining a heating zone and having a length along its longitudinal axis; an inductor coil extending around the receptacle and extending along at least a portion of the length of the receptacle; wherein the inductor coil comprises a first portion disposed closest to a first end of the heating zone, and a second portion disposed closest to a second end of the heating zone, wherein the pitch of the turns of the first portion of the inductor coil are at least substantially constant and the pitch of the turns of the second portion of the inductor coil are variable.

According to an aspect, there is provided an aerosol generating device for generating an aerosol from aerosol-generating material, the device comprising: an inductor coil configured to generate a varying magnetic field; a heating element that is heatable by penetration with the varying magnetic field, the heating element defining a heating zone configured to receive at least a portion of an article comprising aerosol-generating material, and an opening at a first end through which at least a portion of an article is receivable; wherein the heating element is fixed relative to the inductor coil, wherein the inductor coil encircles a first portion of the heating zone closest to the opening such that the proximal portion is heated at least predominantly by inductive heating; and wherein a second portion of the heating zone is free from being encircled by any inductor coil.

According to an aspect, there is provided an aerosol generating system comprising the aerosol generating device of the preceding aspects and an article comprising aerosol generating material.

### BRIEF DESCRIPTION OF THE DRAWINGS

FIG. 1 shows an aerosol generating device;

FIG. 2 shows a schematic cross-sectional view of the aerosol generating device of FIG. 1;

FIG. 3 shows a cross-sectional view of an induction heating assembly of the aerosol generating device of FIG. 1;

FIG. 4 shows a cross-sectional view of another induction heating assembly of the aerosol generating device of FIG. 1; and

FIG. 5 shows a cross-sectional view of another induction heating assembly of the aerosol generating device of FIG. 1.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

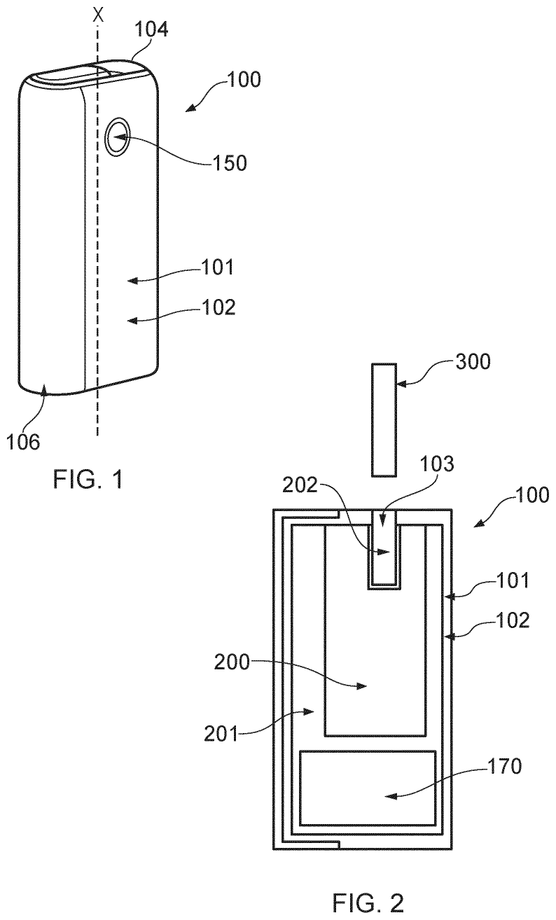

FIG. 1 shows an aerosol generating device 100 for generating aerosol from an aerosol generating medium/material. In broad outline, the device 100 may be used to heat a replaceable article 300 (refer to FIG. 2) comprising the aerosol generating medium, to generate an aerosol or other inhalable medium which is inhaled by a user of the device 100.

The device 100 includes a body or enclosure assembly 101. The enclosure assembly 101 comprises a housing 102 surrounding and housing an aerosol generating assembly 200, which comprises various components for generating an aerosol from the received article. In one example, the article 300 is heated by a heater assembly to generate aerosol. The housing 102 has a housing opening 103 in one end, through which the article may be inserted for heating. In use, the article 300 may be fully or partially inserted into the device where it may be heated by one or more components.

With reference predominantly to FIG. 2, the housing 102 of the device 100 encapsulates the aerosol generating assembly 200. That is the housing 102 surrounds the aerosol generating assembly 200 such that access to the aerosol generating assembly 200 is prevented when the housing is present, with the exception of the opening 103 for inserting the article 300. The housing 102 defines a component cavity 201 in which the aerosol generating assembly 200 is received. The housing 102 acts as a barrier to the component cavity 201 so as to contain the aerosol generating assembly 200 and provide protection from the environment. The housing 102 protects the user from the aerosol generating assembly, for example preventing contact with electrical components and/or providing thermal insulation from the heated components. The housing 102 substantially wholly surrounds the device 100 and the aerosol generating assembly 200. The aerosol generating assembly 200 defines an article receiving chamber 202 extending from the opening 103. The article receiving chamber 202 is isolated from the component cavity 201. A cup and/or tubular member 203 may define the article receiving chamber 202. In this example, the cup and/or tubular member is the susceptor 206. The housing 102 may act as a fluid barrier. The housing 102, in embodiments, fluidly isolates an outer side of the aerosol generating assembly. The housing 102 acts as a shell.

The device 100 defines a proximal end 104, which is generally the end from which the user may inhale the aerosol which is generated, also known as a mouth end, and a distal end 106 which is at an opposite end of the device to the proximal end 104. The device opening 103 is at the proximal end 104. The device 100 is elongate. The device 100 defines a longitudinal axis X which extends in a direction from the proximal end 104 to the distal end 106. The housing 102 surrounds the device 100 so as to form a continuous layer in a circumferential direction around the axis X.

The device 100 also includes a user-operable control element 150, such as a button or switch, which operates the device 100 when pressed. For example, a user may turn on the device 100 by operating the switch. The switch may form part of the housing 102.

The device 100 also comprises an electrical component, such as a connector/port, which can receive a cable to charge a battery of the device 100. For example, the connector may be a charging port, such as a USB charging port. In some examples the connector may be used additionally or alternatively to transfer data between the device 100 and another device, such as a computing device.

The device 100 comprises a power source 170 (refer to FIG. 2), for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

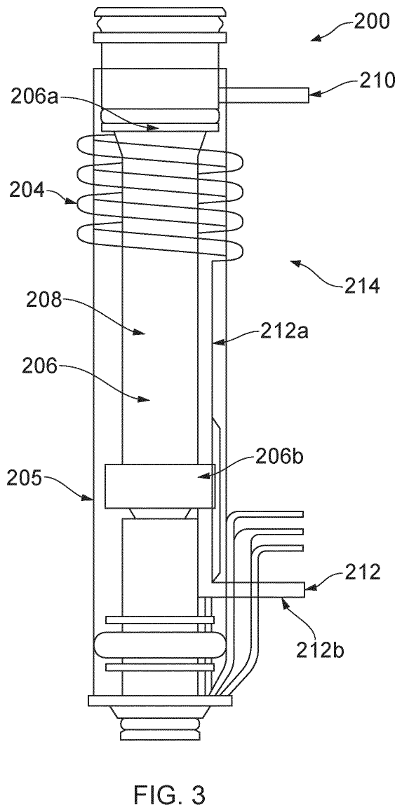

FIG. 3 shows a cross-sectional view of the aerosol generating assembly 200. In one example, the aerosol generating assembly 200 comprises an induction-type heater, including a magnetic field generator 214. The magnetic field generator 214 comprises an inductor coil 204. The aerosol generating assembly 200 comprises a heating element 206. The heating element is also known as a susceptor 206.

The inductor coil 204 is in communication with a power source, which energises the coil to generate a varying magnetic flux. The magnetic flux generates a current in the susceptor 206, which in turn causes the susceptor 206 to heat. The susceptor is in heat communication with the article 300, and heats the article 300 to generate an aerosol. The heating element 206 is tubular. The heating element 206 is substantially cylindrical. The heating element 206 is hollow. The heating element 206 acts as a receptacle.

The heating element 206, acting as the receptacle, includes an opening for receiving the article. The opening is at the proximal end. The receptacle defined by the heating element 206 is configured to receive at least part of the article 300. In embodiments, the heating element 206 defines the entire receptacle. In embodiments as described below the heating element and the receptacle are different components. The heating element 206 defines a heating zone 208. The heating zone 208 occupies the same space as the receiving chamber 202. A length of the susceptor 206 extends in a longitudinal direction of the longitudinal axis X of the device 100.

The inductor coil 204 is a helical coil. The coil 204 extends around a coil support 205. The coil support 205 acts to hold the coil in position. The coil support 205 extends in a longitudinal direction of the longitudinal axis X. The coil comprises a number of turns. The turns extend around the coil support 205. The coil support 205 is tubular. The heating element extends in the coil support 205. The heating element 206 is encircled by the coil support 205. The heating element 206 is encircled in part by the inductor coil 204.

The magnetic field generator includes first and second connector portions 210, 212. The first connector portion 210 electrically connects a proximal end of the inductor coil 204 to the power source 170. The second connector portion 212 electrically connects a distal end of the inductor coil 204 to the power source 170. The inductor coil 204 and the connector portions 210, 212 form a continuous electrically conductive element. The inductor coil 204 and the connector portions 210, 212 form a one-piece component.

The inductor coil 204 encircles a first portion of the heating element 206. The first portion of the heating element 206 is at proximal end. The proximal end of the heating element 206 is proximal to the proximal end 104 of the device. By providing the inductor coil 204 at the proximal end of the heating element it is possible to heat the proximal end prior to the distal end of the heating zone. This helps to minimise the time required to provide a desired quantity of aerosol to the user as the aerosol is generated initially proximate to the opening.

The inductor coil 204 comprises four turns. It will be understood that the number of turns may differ. In embodiments, the inductor coil may comprise up to 20 turns. In an embodiment, the inductor coil comprises 10 turns. A pitch of the inductor coil 204 is constant along the length of the inductor coil 204. The pitch may be defined by the separation between successive turns of the coil. In this embodiment, the pitch is 2.8 mm, i.e., the separation of successive turns of the inductor coil is 2.8 mm. In embodiments, the pitch may be between 1.5 mm and 4.5 mm.

In other embodiments, the pitch varies along the length of the inductor coil 204. The pitch may progressively decrease along at least part of the length of the inductor coil 204, in a proximal to distal direction in relation to the opening of the device. In embodiments, the pitch may progressively increase along at least part of the length of the inductor coil 204, in a proximal to distal direction in relation to the opening of the device.

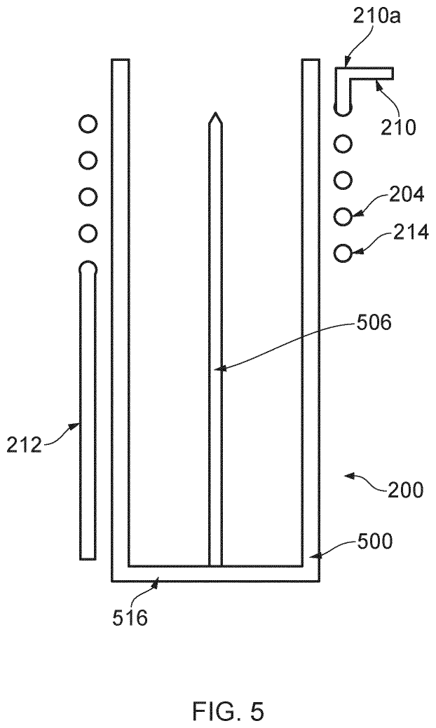

The first connector portion 210 includes an angled bend 210a (refer to FIG. 5). The angled bend has an angle of substantially 90 degrees. The angled bend 210a defines a juncture between the inductor coil 204 and the first connector portion 210. In other embodiments, the angled bend may be another angle. In embodiments, the angled bend is between 45 degrees and 135 degrees. The angled bend allows the inductor coil 204 to be connected to a power source while minimising the length of the inductor coil 204 so that it only overlaps the susceptor. This helps to minimise energy usage. It will be understood that the inductor coil is entirely overlapped by the susceptor in the axial direction X. That is, there is no part of the inductor coil which is not adjacent to the susceptor. The susceptor defines a first end 206a and a second end 206b, the inductor coil being disposed between the first end and the second end.

The second connector portion 212 includes a first section 212a which extends in the axial direction of the device 100. The first section 212a of the second connector portion 212 is at least substantially parallel to the longitudinal axis X. The first section 212a of the second connector portion 212 is at least substantially parallel to an axis of the inductor coil 204. The first section 212a of the second connector portion 212 is adjacent to a second portion of the susceptor 206. The second portion of the susceptor 206 is free from being encircled by the inductor coil 204. The second connector portion 212 extends from the inductor coil 204 towards the distal end 106 of the device. The second connector portion 212 includes an angled bend in order to extend at least substantially perpendicular to the longitudinal axis of the device. A second section 210b of the second connector portion 212 is at least substantially perpendicular to an axis of the inductor coil 204. This helps to enable the first connector portion to connect to the power source 170 with a minimal length of connector. The angled bend connects the first section 212a and the second section 210b.

The inductor coil 204 extends along between 10% and 80% of the longitudinal extent of the susceptor 206. In embodiments, the inductor coil extends along between 20% and 40% of the longitudinal extent of the susceptor 206. In this embodiment, the inductor coil extends along 30% of a longitudinal extent of the susceptor.

In use, alternating current is supplied to the coil 204 by the power source 170. The alternating current in the inductor coil 204 generates a varying magnetic flux adjacent to the first portion of the susceptor. The magnetic flux generates a current in the first portion of the susceptor 206, which in turn causes the first portion of the susceptor 206 to heat. As the use session continues, heat is conducted from the first portion of the susceptor to the second portion of the susceptor. It will be understood that the first portion of the susceptor is heated before the second portion of the susceptor. The second portion of the susceptor undergoes only minimal direct heating, due to the proximity of the second connector 212.

In use, the first portion of the susceptor is heated predominantly by inductive heating, due to the proximity of the inductor coil 204. The second portion of the susceptor is heated predominantly by conductive heating, as it is spaced from the inductor coil. The second connector does not generate a significant inductive heating effect. It will therefore be understood that the first portion of the susceptor will heat sooner than the second portion of the susceptor. That is, the first portion of the susceptor will attain a higher temperature at a certain point in the use session than the second portion of the susceptor. The susceptor is progressively heated along its length, as heat is conducted to and along the second portion.

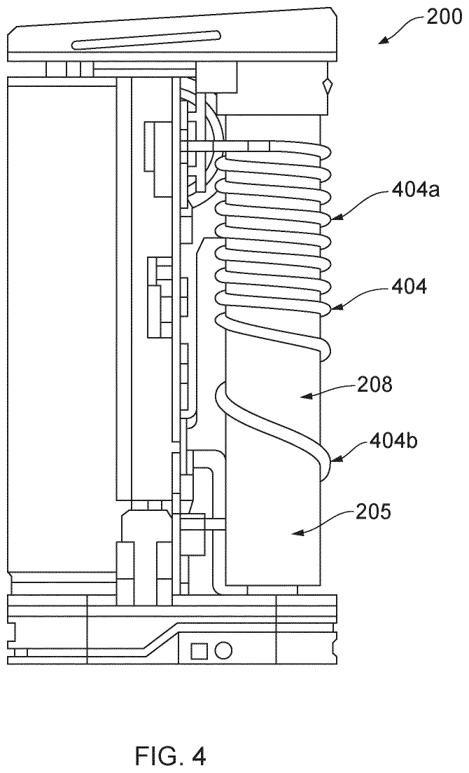

FIG. 4 shows an aerosol generating assembly of another embodiment of an aerosol generating device. This embodiment differs from the embodiments described by reference to FIG. 3 in that the inductor coil 404 includes a first portion 404a of fixed pitch and a second portion 404b of variable pitch. The first portion 404a is closer to the proximal end of the device and the second portion 404b is closer to the distal end of the device. That is, the first portion 404a is closer to the opening 103 than is the second portion 404b. The second embodiment is generally similar to the first embodiment and like reference numerals will be used. The inductor coil 404 of this embodiment extends along a greater longitudinal extent of the susceptor 206, relative to the embodiments described by reference to FIG. 3. In this embodiment, the inductor coil 404 extends over 80% of the longitudinal extent of the susceptor. In other embodiments, the inductor coil may extend over between 60% and 100% of the longitudinal extent of the susceptor.

The inductor coil 404 includes a first portion 404a of fixed pitch. That is, the distance between successive turns of the coil 404 is constant along the longitudinal extent of the first portion 404a. The inductor coil 404 includes a second portion 404b of varying pitch. That is, the distance between successive turns of the coil 404 varies along the longitudinal extent of the second portion 404b. The first portion 404a comprises 50% of the longitudinal extent of the coil 404. The second portion 404b comprises 50% of the longitudinal extent of the coil. The entire longitudinal extent of the coil is comprised by the first and second portions 404a, 404b.

The first portion 404a has a narrower pitch than the second portion 404b. That is, successive turns of the coil are closer together in the first portion 404a than in the second portion 404b. The pitch of the second portion 404b is narrower at the end connected to the first portion 404a than at the other end. That is, successive turns of the coil are closer together at the end of the second portion 404b which is connected to the first portion 404a, relative to the other end of the second portion 404b. The pitch of the first portion 404a is narrower than the maximum pitch of the second portion 404b. That is, the separation of subsequent turns is lower in the first portion 404a.

The region of the susceptor adjacent to the first portion 404a is heated predominantly by induction. At least a portion of the region of the susceptor adjacent to the second portion 404b is heated predominantly by conduction of heat from the region of the susceptor adjacent to the first portion 404a. In some embodiments, the entirety of the region of the susceptor adjacent to the second portion 404b is heated predominantly by conduction. In other embodiments, only a portion adjacent to the distal end of the second portion 404b is heated predominantly by conduction. It will be understood that an intermediate region may exist between the portion of the susceptor heated predominantly by induction and the portion of the susceptor heated predominantly by conduction.

The first portion 404a includes 7.5 turns of the coil. The separation between successive turns is 2.8 mm. In other embodiments, the first portion 404a may include between 1 and 20 turns of the coil. The separation between successive turns may be between 0.5 mm and 10 mm. The second portion 404b includes 2.25 turns of the coil. In other embodiments the second portion 404b may include between 1 and 20 turns of the coil.

The first portion 404a allows one end of the susceptor 206 to be heated relatively quickly to minimise time to operating temperature. The second portion 404b allows for sequential heating of the susceptor along its longitudinal extent. This provides for progressive heating of smoking material. As the coil is controlled at the ‘first portion’, the amount of direct heating achieved in the ‘second portion’ is determined by the ratio of first portion turns to second portion turns.

Compared to the first embodiment, the portion of the susceptor adjacent to the second portion 404b of the coil is subjected to progressive heating. It will be understood that this means that the balance between inductive heating and conductive heating varies smoothly across a longitudinal extent of the susceptor. This ensures that the operating temperature is achieved at all parts along the longitudinal extent of the susceptor during the heating session. This avoids the possibility that parts of the smokable material may be subjected to temperatures in excess of the operating temperature or may not attain the operating temperature.

In another embodiment, shown in FIG. 5, the arrangement of the heating element differs. In the above described embodiments, the heating element acts as the receptacle, with the heating element defining the heating zone. In embodiments, the heating element and the receptacle are discrete. As shown in FIG. 5, a receptacle 500 defines the heating zone. A heating element 506 extends in the heating zone. The heating element 506 protrudes in the heating zone. The heating element is formed from a material susceptible to heating by a magnetic field. The receptacle is free from a material susceptible to heating by a magnetic field. The heating element 506 upstands in the receptacle 500. The receptacle is tubular, and comprises an end wall 516. In this embodiment, the receptacle is formed from polyether ether ketone material (PEEK). The heating element is 506 in the form of an elongate element, such as a blade or pin. The heating element 506 is configured to penetrate the article containing aerosol generating material when the article is received in the heating zone. In other respects, the embodiment shown in FIG. 5 is similar to the embodiment shown in FIG. 3 and like reference numerals have been used.

The arrangement of FIG. 5 may also be employed with an induction coil according to the embodiment of FIG. 4. That is, the induction coil may include a first portion of fixed pitch and a second portion of varying pitch, the pitch of the second portion becoming less narrow towards the distal end of the device.

In a further embodiment, the heating element 506 may be provided in the article 300. In such an embodiment, the device is free from a heating element. In an example, the heating element is provided by a member formed of material which is heatable by penetration with a varying magnetic field embedded within the aerosol generating material. In examples, the member is a three dimensional coil or a planar member. In other examples, the heating element is provided by particles of material heatable by penetration with a varying magnetic field dispersed through the aerosol generating material.

The above aerosol generating devices may be operated in a first mode and in a second mode.

In the first mode, the inductor coil is energised so that the temperature of a portion of the heating zone adjacent to the coiled portion of the inductor coil attains the following temperatures:

| Cumulative time (s) | Temperature (° C.) |
|---|---|
| 30 | 230 |
| 192 | 240 |
| 219 | 255 |
| 270 | 265 |

In the second mode, the inductor coil is energised so that the temperature of a portion of the heating zone adjacent to the coiled portion of the inductor coil attains the following temperatures:

| Cumulative time (s) | Temperature (° C.) |
|---|---|
| 20 | 240 |
| 128 | 260 |
| 182 | 270 |
| 200 | 260 |

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol generating device for generating an aerosol from aerosol-generating material, the device comprising:
a magnetic field generator comprising an inductor coil configured to generate a varying magnetic field; and
a heating element that is heatable by penetration with the varying magnetic field, the heating element defining a heating zone configured to receive at least a portion of an article comprising aerosol-generating material;
wherein the heating element is fixed relative to the inductor coil;
wherein the inductor coil encircles a first portion of the heating zone such that the first portion is heated at least predominantly by inductive heating; and
wherein a second portion of the heating zone is free from being encircled by any inductor coil so that the second portion of the heating zone is heated predominantly by conductive heating.

2. The aerosol generating device of claim 1, wherein the heating element defines an opening at one end through which at least a portion of an article is receivable, and wherein the first portion of the heating zone is proximal to the opening.

3. The aerosol generating device of claim 1, wherein the heating element defines an opening at one end through which at least a portion of an article is receivable, and wherein the second portion of the heating zone is distal to the opening.

4. The aerosol generating device of claim 1, wherein the pitch of the inductor coil is at least substantially constant along the length of the coil.

5. The aerosol generating device of claim 1, wherein the heating zone comprises a first end and a second end, the inductor coil being disposed between the first end and the second end.

6. The aerosol generating device of claim 1, wherein the magnetic field generator comprises a first connector portion at a first end of the inductor coil and a second connector portion at a second end of the inductor coil, wherein at least one of the first and second connector portion extends at least partly in an axial direction of the aerosol generating device.

7. The aerosol generating device of claim 6, wherein at least one of the first and second connector portions at least partly overlaps the second portion of the heating zone.

8. The aerosol generating device of claim 6, wherein the at least one of the first and second connector portions is linear.

9. The aerosol generating device of claim 6, wherein at least one of the first and second connector portions comprises an angled bend.

10. The aerosol generating device of claim 9, wherein the angled bend defines a juncture between the inductor coil and the at least one of the first and second connector portions.

11. (canceled)

12. The aerosol generating device of claim 1, wherein an axial extent of the second portion is between 10% and 80% of the axial extent of the heating element.

13. (canceled)

14. The aerosol generating device of claim 1, wherein the heating element is substantially tubular.

15. An aerosol generating system comprising the aerosol generating device of claim 1 and an article comprising aerosol generating material.

16. An aerosol generating device for generating an aerosol from aerosol-generating material, the device comprising:
a receptacle defining a heating zone and having a length along its longitudinal axis;
an inductor coil extending around the receptacle and extending along at least a portion of the length of the receptacle;
wherein the inductor coil comprises a first end portion disposed closest to a first end of the heating zone, and a second end portion disposed closest to a second end of the heating zone,
wherein the first end portion of the inductor coil comprises a first number of turns per unit length such that at least a portion of a heating element received in the heating zone is heated predominantly by inductive heating; and wherein the second end portion comprises a second number of turns per unit length, the second number of turns per unit length being less than the first number of turns per unit length to the extent that at least a portion of a heating element received in the heating zone is heated predominantly by conduction.

17. The aerosol generating device of claim 16 comprising a heating element that is heatable by penetration with the varying magnetic field.

18. The aerosol generating device of claim 17 wherein the heating element upstands in the receptacle.

19. The aerosol generating device of claim 17 wherein the receptacle comprises the heating element.

20. An aerosol generating system, comprising the aerosol generating device of claim 16, and an article comprising aerosol generating material, the article comprising a heating element that is heatable by penetration with the varying magnetic field.

21. An aerosol generating device for generating an aerosol from aerosol-generating material, the device comprising:
a receptacle defining a heating zone and having a length along its longitudinal axis;
an inductor coil extending around the receptacle and extending along at least a portion of the length of the receptacle;
wherein the inductor coil comprises a first portion disposed closest to a first end of the heating zone, and a second portion disposed closest to a second end of the heating zone,
wherein the pitch of the turns of the first portion of the inductor coil are at least substantially constant and the pitch of the turns of the second portion of the inductor coil are variable.

22. (canceled)

23. An aerosol generating system comprising the aerosol generating device of claim 21 and an article comprising aerosol generating material.
